(19) United States
(12) Patent Application Publication
(10) Pub. No.: US 2017/0184133 A1
(43) Pub. Date: Jun. 29, 2017

(54) METHOD FOR MANUFACTURING A PRESSURE ACCUMULATOR

(71) Applicant: PLASTIC OMNIUM ADVANCED INNOVATION AND RESEARCH, Brussels (BE)

(72) Inventors: Eric BOUCAUX, Elincourt Sainte Marguerite (FR); David HILL, Commerce Township, MI (US); Wilfried LEMASSON, Marest sur Matz (FR); Pierre LACOME, Lachelle (FR)

(73) Assignee: PLASTIC OMNIUM ADVANCED INNOVATION AND RESEARCH, Brussels (BE)

(21) Appl. No.: 15/304,960

(22) PCT Filed: Apr. 13, 2015
(86) PCT No.: PCT/FR2015/050979

§ 371 Date: Oct. 18, 2016

(30) Foreign Application Priority Data
Apr. 23, 2014 (FR) 1453636
Sep. 4, 2014 (FR) 1458253

(51) Int. Cl. F15B 1/24; B29C 49/04; F15B 1/22; B29C 49/20

(52) U.S. Cl. CPC F15B 1/24; B29C 49/20; B29C 49/04; F15B 1/22; B29C 2049/2047; B29K 2105/258

(57) ABSTRACT

A method for manufacturing a vehicle pressure accumulator, in which a thermoplastic parison is used to form an enclosure around a chamber by applying at least one portion, at least partially molten, of the parison onto at least one portion of the chamber, to attach the parison to the chamber.

The invention concerns pressure accumulators for vehicles.

Certain types of hybrid vehicles contain a hydraulic pump/motor system able to charge hydraulic accumulators with oil to store this energy in the form of a pressure reserve. A hydraulic machine connected to driving wheels of the vehicle can operate as a motor to deliver a mechanical power to the wheels by drawing upon the energy stored in the hydraulic accumulators, or as a pump to recharge these accumulators during braking operations of the vehicle, in order to recover at least a portion of the kinetic energy of the vehicle.

An accumulator of piston type comprises an enclosure inside which there is disposed a piston chamber. A movable piston assembly is mounted to slide in the chamber. Generally the chamber is connected to a gas circuit which sends gas into the chamber and closes it to maintain a constant quantity of gas present. The movable assembly moves in one direction of sliding when oil is delivered to compress the gas (for example, nitrogen), and it is displaced in the other direction of sliding (i.e., the opposite direction) to deliver the oil to the outside of the accumulator.

Another type of hydraulic accumulator is a bladder type, which comprises an enclosure inside which is disposed a bladder able to contain gas, preferably nitrogen. During the recovery of energy, oil is delivered into the enclosure around the bladder. Thus, the bladder full of gas is compressed by the oil. When it is desired to draw upon the energy stored in the enclosure of the accumulator, the pressure exerted by the oil on the bladder is reduced. If this pressure is less than the pressure exerted by the bladder, the oil is evacuated from the enclosure. This pressure accumulator also comprises a filament winding around its enclosure.

The installation of the chamber in the enclosure of the accumulator is difficult because it takes place in an enclosure already produced, with the need to arrange and tighten up a lot of elements. This installation is manual, and thus very complex, time-consuming and even dangerous, since it entails risks of cutting one's fingers and muscle complications for the worker.

One goal of the invention is thus to facilitate the fabrication of a pressure accumulator.

For this purpose, there is provided a method of fabrication of a pressure accumulator for a vehicle wherein an enclosure around a chamber is formed from a parison of thermoplastic material by applying at least one portion, at least partly molten, of the parison to at least one portion of the chamber so as to attach the parison to the chamber.

Thus, during the parison stage the enclosure is attached to the chamber. This reduces the risks of injury. In particular, it is no longer necessary to gain access to the interior of the enclosure once it has been molded for purposes of attaching the chamber there.

By thermoplastic material is meant any thermoplastic polymer, including thermoplastic elastomers, as well as their blends. By the term “polymer” is meant both homopolymers and copolymers (in particular binary or ternary ones). Examples of such copolymers, without being limited to these, are: randomly distributed copolymers, sequenced copolymers, block copolymers and graft copolymers.

Any type of thermoplastic polymer or copolymer whose melting temperature is less than the temperature of decomposition is suitable. Synthetic thermoplastics having a melting range spread out over at least 10 degrees Celsius are particularly well suited. An example of such materials are those having a polydispersion of their molecular mass.

In particular, polyolefins, thermoplastic polyesters, polyketones, polyamides and their copolymers can be used. A blend of polymers or copolymers can also be used, as well as a blend of polymeric materials with inorganic, organic and/or natural ballast, such as but not limited to: carbon, clays, salts and other inorganic derivatives, natural or polymeric fibers. It is likewise possible to use multilayered structures comprised of stacked and integrated layers containing at least one of the polymers or copolymers described above.

One polymer often used is polyethylene. Excellent results can be achieved with high density polyethylene (PEHD).

The wall of the enclosure can be formed by a single layer of thermoplastic material or two layers. One or more other additional layers may advantageously be formed by barrier layers to liquids and/or gases. Preferably, the nature and the thickness of the barrier layer are chosen so as to limit to the utmost the permeability of the liquids and gases in contact with the interior surface of the enclosure. Advantageously, this layer can be based on a barrier resin, that is, a resin impermeable to fuel, such as EVOH (partially hydrolyzed ethylene-vinyl acetate copolymer).

In one embodiment, the chamber comprises a bladder.

In another embodiment, the chamber comprises at least one piston assembly.

Thus, the method is suitable to being implemented for the two main types of accumulators mentioned above.

Advantageously, the chamber is attached to an extrusion head of the parison.

Thus, the extrusion head provides the support for the chamber during the molding of the enclosure.

This attachment can take place by means of a robot.

This avoids a manual intervention in the molding layout and reduces the risks of accidents for the workers.

Preferably, the parison is extruded about the chamber.

Advantageously, the portion or each portion of the chamber is heated prior to the application of the parison to that portion.

Thus, the operation of overmolding of the enclosure on the portion of the chamber is facilitated.

Preferably, the application is done by pressure.

Thus, it is even more efficient and the supporting of the chamber at its end is assured.

Advantageously, the application is done by means of the closing of a mold for the molding of the enclosure from the parison.

Thus, the attachment of the chamber to the enclosure takes place during the blow molding of the parison, which makes it possible to increase the speed of fabrication of the whole and the method does not require a large number of tools.

The portion of the chamber or at least one of the portions of the chamber can form an upper end of the chamber, especially a valve.

The portion of the chamber or at least one of the portions of the chamber can also form a lower end of the chamber, especially a valve.

Advantageously, the portion of the chamber or at least one of the portions of the chamber constitutes an assembly composed of elements which can only be separated by destruction of at least one of the elements. It can also be referred to as a monoblock design.

Thus, the monoblock portion can be secured during the blow molding of the parison, instead of being assembled of several parts. This is also called an insert. The parison is applied against this portion during the closing of the mold.

Preferably, the portion of the chamber or at least one of the portions of the chamber has an external face formed by a thermoplastic material and the application is performed by applying the parison to this face.

The compatibility of the materials thus allows the welding of the portion of the chamber to the enclosure.

Preferably, the application is done to two portions of the chamber which are spaced apart, such as the ends of the chamber.

The invention also specifies a pressure accumulator for a vehicle, comprising:
an enclosure of thermoplastic material, and
a chamber housed in the enclosure, the enclosure being at least partly overmolded on at least one portion of the chamber.

Advantageously, the chamber comprises a bladder.

It is known that there are piston accumulators of type I, III, and IV. The accumulators of type I are made of metal, whereas types III and IV have an external composite structure. The accumulators of type III have little fatigue strength. Piston accumulators of type IV are in existence. They are designed for a vertical installation (relative to the ground). These accumulators are not adapted for an installation on a motor vehicle. In fact, in such an instance, it is advisable for the accumulator(s) to be installed flat (that is, horizontally with respect to the ground) beneath the frame of the vehicle. Piston type accumulators have also been proposed for a motor vehicle. These known accumulators (so-called type I) make use of steel assembly parts, which makes them particularly heavy, bulky and costly.

It is thus desirable to provide a piston accumulator of type IV which offers a suitable strength, and at the same time maintains a particularly reduced weight. It is also desirable to provide such an accumulator which is compact and with little permeability.

This is why, in one embodiment, the chamber comprises a piston assembly, the overmolding of the enclosure takes place on portions of the chamber forming at least one portion of a first nozzle for the inlet and outlet of a pressurized gas and at least one portion of a second nozzle for the inlet and outlet of a pressurized liquid.

In particular, the piston chamber can be outfitted with nozzles projecting toward the outside of the chamber and a portion of the enclosure can be overmolded at these nozzles.

Moreover, by overmolding a portion of the enclosure at these nozzles, the piston chamber is integrated with the enclosure and the weight of the accumulator is decreased because no steel part is used to assemble the enclosure with the chamber. Moreover, a pressurized gas (such as nitrogen or helium) can enter and leave the chamber via the first nozzle, and a pressurized liquid (such as oil) can enter and leave the chamber via the second nozzle.

In another embodiment, the chamber comprises a piston assembly, the overmolding of the enclosure takes place on at least one portion of a first peripheral nozzle for the inlet and outlet of a pressurized gas, the chamber comprises a second central nozzle for the inlet and outlet of a pressurized liquid, and the first and second nozzles are placed on the same side of the accumulator.

Advantageously, the first and second nozzles are concentric.

In one particular embodiment, the first and second nozzles can be secured in integral manner to the piston chamber, for example, by welding or any other means serving this purpose.

In one particular embodiment, the piston chamber can itself be made of composite material and be assembled on nozzles of different material.

In one particular embodiment, the piston system can be molded by the assembly of two half shells, between which a movable piston assembly has been previously placed.

For example, each half shell comprises one half of a piston chamber and first and second nozzles. For example, each half shell can be produced by molding of a metallic material or a composite material.

In one particular embodiment, the first and second nozzles are diametrically opposite (i.e. facing each other). Such a configuration allows, after overmolding of the enclosure on these nozzles, a good mechanical stability of the assembly (i.e. little vibration).

In another particular embodiment, the first and second nozzles are off center in relation to each other.

The first and second nozzles can have any desired shape. Preferably, they are of tubular shape. They can have the same or different diameter.

In another particular embodiment, the piston chamber can have more than two nozzles. For example, the piston chamber can have a third nozzle connected to another pressurized gas circuit, serving as a backup circuit.

In one advantageous embodiment, the outer surface of the enclosure is covered by a coating (i.e. outer layer) of composite material.

Preferably, this coating is based on fibers with elevated modulus of elasticity and preferably fibers of glass or carbon.

The movable piston assembly is preferably tight.

According to one particularly advantageous embodiment, the accumulator comprises a sensor designed to detect the position of the movable piston assembly inside the piston chamber. The sensor can be of the type with or without contact.

In one particular embodiment, the accumulator can comprise an infrared sensor or an ultrasound sensor mounted in the piston chamber, for example but not exclusively to measure the exact position of the piston (i.e. movable assembly).

In another particular embodiment, the piston chamber is provided with a series of switches (or integrates them inside its enclosure), or a variable resistance cell, and the movable piston assembly can be equipped with a magnet designed to control the closing of the switches. Thus, the unit formed by the chamber and the movable piston assembly can act as a potentiometer. In fact, each position of the movable piston assembly in the piston chamber can correspond to a different resistance value.

Finally, the invention provides a layout for the fabrication of a pressure accumulator for a vehicle, comprising:
a mold,
means of supporting a chamber so that it extends inside the mold, and
means of forming an enclosure around the chamber by blow molding of a parison in the mold and of applying at least a portion of the parison to at least a portion of the chamber.

Embodiments of the invention will now be described by non-limiting examples and supported by the enclosed drawings, in which:

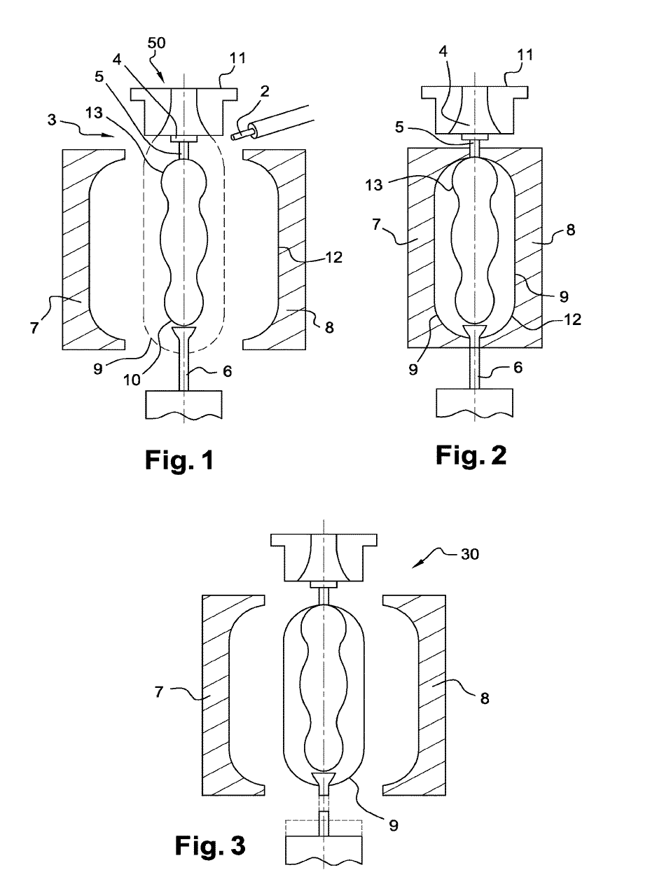

FIGS. 1 to 3 illustrate schematically and in axial section a method for fabrication of a pressure accumulator according to a first embodiment of the invention;

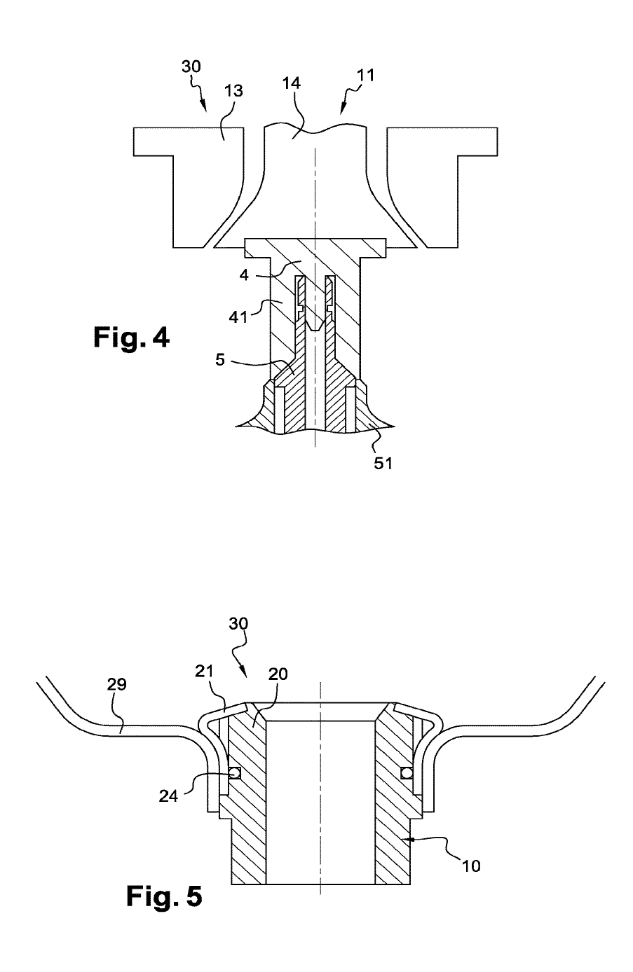

FIG. 4 illustrates an axial section view of the system for attaching the extrusion head to the bladder;

FIG. 5 is an axial section view of a lower end of a chamber secured to an enclosure of this accumulator; and

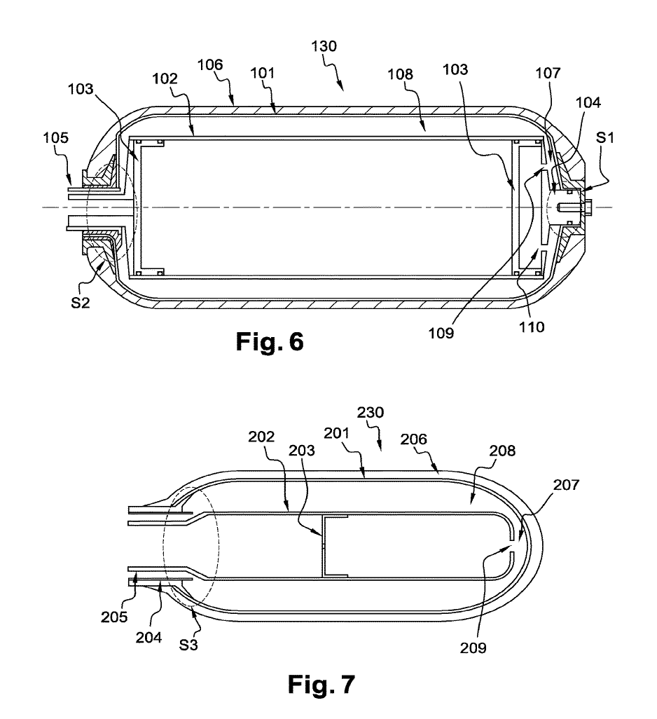

FIGS. 6 and 7 are axial section views of two other embodiments of an accumulator according to the invention.

### FIRST EMBODIMENT

First of all a layout and a method for the realization of an accumulator according to a first embodiment of the invention shall be described making reference to FIGS. 1 to 3.

The fabrication layout 50 comprises an extrusion head 11 making it possible to extrude a parison of thermoplastic material 9. The layout comprises a mold to form an enclosure from the parison, having for example two mold portions 7 and 8, mounted so as to be movable with respect to each other, here in a horizontal direction, and with respect to the head 11. The head comprises means of supporting a bladder 3 such that the bladder extends between the mold portions, whether the mold is open or closed. The layout also comprises a lower blowpipe 6 extending vertically to the head 11 and making it possible to inject gas into the parison during the blow molding of the latter to form the enclosure. The layout also comprises a robot having an arm 2 able to secure a bladder to the extrusion head and to the blowpipe by the upper and lower ends of the bladder.

The method takes place as follows.

In an external station a heating of the portions of the bladder 3 to which a parison will be applied is performed. In this example, the bladder 3 has one end 5 and the opposite end 10 made of thermoplastic material. Thus, by heating these ends 5 and 10, the latter are placed in a partly molten state. In one particular embodiment, this heating can be of infrared type. Alternatively, this heating can be of laser type, or by hot air current, or a heating by a mirror. This heating at an external station advantageously allows a saving of cycle time. In fact, the heating occurs independently of the blow molding operations in the mold.

In another embodiment, the heating of all or a portion of the bladder can be accomplished in the area of the mold. For example, the extrusion head can be outfitted with heating means, such as hot air blow molding means. This embodiment has the advantage of enabling a compact layout.

Next, during a step inside the layout 50, the robot arm 2 attaches the upper rigid monoblock end 5 of the bladder 3 to a lower portion of the extrusion head 4. This bladder 3 is likewise attached by the arm to the blowpipe 6, at the opposite end 10. The bladder, outside of its rigid monoblock ends 5 and 10, comprises a deformable flexible bag 13 forming a gas-tight chamber. The two portions of the mold are situated on either side of the bladder, the head, and the blowpipe.

In one variant not illustrated, the end 10 of the bladder 3 is not attached to the blowpipe.

In a following step, shown in FIG. 1, a parison 9 of thermoplastic material, shown by dotted lines, is extruded and descends vertically from the extrusion head 11 so as to surround the bladder. Thus, the bladder is contained in the parison 9.

Once the extrusion is finished, a draping is performed to maintain the parison in position in the mold and a pre-blowing to stretch the parison and prevent contact between the parison and the bladder during the mold closure which will ensue. Then, in a further step illustrated in FIG. 2, the mold is closed: the two mold portions 7 and 8 are moved toward each other. The top and bottom ends of these two portions compress the parison at the two respective preheated ends of the bladder: in the area of the end 5 held by the extrusion head and in the area of the end 10 supported on the blowpipe 6.

In a following step, not illustrated, the blowpipe injects air into the parison, around the bladder. Thus, the walls of the parison are compressed against the walls 12 of the mold. The parison thus takes the shape of the mold to become the enclosure of the accumulator, and contains the bladder to which it is rigidly attached in the area of its ends 5 and 10.

During the next step, which can be seen in FIG. 3, the two mold portions 7 and 8 are withdrawn in opposite directions, and the unit comprising the enclosure produced and the bladder attached to the two upper and lower ends of the enclosure are obtained. The basic elements for a pressure accumulator 30 are thus obtained.

The upper end 5 of the bladder forms, for example, a valve in order to connect the bladder to the conduits of the vehicle in order to bring gas into the bladder, while the end 6 can form a valve and hold the bladder in place in the enclosure 9 of the pressure accumulator.

FIG. 4 illustrates the system for attaching the upper end 5 of the chamber to the extrusion head 11. The extrusion head 11 comprises a head body 13 which is fixed in relation to a frame of the layout and a movable portion such as a punch 14. The punch is mounted to slide in relation to the body in the vertical direction. In the top position, it is in contact with the body all around the punch 14, leaving no space between the punch and the body 13, so that any extrusion of material is prevented, the head being closed. In the bottom position, it leaves a symmetrical space of revolution about the vertical axis between the punch and the body in order to allow the extrusion of the thermoplastic material and the descending of a parison 9, the head then being open. The layout comprises a support 41 rigidly attached to the lower face of the punch 14, having a seat to receive the upper portion 5 of the bladder, which is open toward the bottom, in order to carry the latter in a movable manner. The movable connection between the bladder and the support can be done by various conventional means such as a holding magnet and/or a pressure ball. The overmolding of the enclosure 9 takes place at a lower portion 51 of the end of the chamber which extends beyond the bottom of the support.

The attachment of the lower end of the chamber 3 to the blowpipe 6 is done by conventional means, not shown.

FIG. 5 illustrates a detail of the first embodiment in the area of the lower end 10 of the bladder, forming an insert. The insert 10 is a monoblock, that is, it can only be separated into several elements by the destruction of at least one of these elements. The enclosure 29 of the accumulator and the thermoplastic layer 21 of this insert onto which the enclosure is overmolded are seen, this layer being applied to the metallic part 20. Alternatively, the application of the layer 21 to the part 20 can be eliminated, the layer 21 can be dispensed with and the overmolding of the enclosure 29 can be performed directly on the metallic part 20 in grooves, orifices or other types of reliefs and cavities provided for this purpose on the surface of the part 20 to assist with this overmolding. The insert likewise has a seal 24 which enables tightness between the part 20 and the enclosure 29 or the part 20 and the layer 21. This seal can be made of rubber.

Two other embodiments of pressure accumulators making reference to FIGS. 6 and 7 and produced by means of the method according to the invention shall now be described. Unlike the accumulator of the first embodiment, this one is a piston accumulator.

### SECOND EMBODIMENT

FIG. 6 illustrates schematically a pressure accumulator according to the second embodiment of the invention.

The pressure accumulator 130 comprises an enclosure 101 inside which is placed a piston chamber 102 comprising a piston assembly 103 mounted to slide in the chamber 102, and placed in a first position in the figure. Reference 103′ illustrates the same piston assembly in a second position. The chamber 102 is equipped with a first nozzle 104 for the inlet and outlet of a pressurized gas and a second nozzle 105 for the inlet and outlet of a pressurized liquid. These two nozzles extend at opposite axial ends of the accumulator. The accumulator comprises an enclosure 101 covered by an exterior reinforcement layer 106. In one particular embodiment, this layer 106 can be a winding of carbon fibers. The enclosure 101 is made of thermoplastic material.

As illustrated in the example of FIG. 5, the enclosure 101 is overmolded onto the first nozzle 104 and onto the second nozzle 105. The zone of overmolding of the first nozzle 104 is referenced as S1 and that of the second nozzle 105 as S2. These so-called “overmolding” operations have been performed by means of the method of the invention as implemented in the first embodiment described above. Thus, the piston chamber 102 has been attached in the area of the nozzle 104 to the bottom of the extrusion head. Likewise, the nozzle 105 of the chamber has been attached to the blowpipe. The steps of the method also make it possible here to produce the accumulator in a faster and easier manner and with less risk than in the prior art.

Spaces 107, 108 are formed between the enclosure 101 and the piston chamber 102. The space 107 extends in the axial direction between these two elements, while the space 108 extends between them in the radial circumferential direction. Advantageously, the dimensions of the enclosure 101 and of the piston chamber 102 can be chosen so as to contain a desired quantity of gas in these spaces 107, 108. The piston chamber 102 has orifices 109, 110 configured to allow a circulation of the pressurized gas between the chamber 102 and the spaces 107, 108.

### THIRD EMBODIMENT

In a third embodiment of an accumulator produced by means of the method according to the invention and illustrated in FIG. 7, the accumulator is identical to that of the second embodiment except for the following characteristics. Similar elements carry number references increased by 100, where necessary.

The first nozzle 204 for the inlet and outlet of a pressurized gas, such as nitrogen, is peripheral, and the second nozzle 205 for the inlet and outlet of a pressurized liquid is central, the first and second nozzles being placed this time on the same side of the accumulator. Furthermore, in this case, they are concentric.

As illustrated in the example of FIG. 7, the enclosure 201 is overmolded on the first peripheral nozzle 204. The zone of overmolding of the first peripheral nozzle 204 is referenced as S3. As in the preceding embodiment, the piston chamber 202 comprises an orifice 209 configured to allow a circulation of the pressurized gas between the chamber 202 and the spaces 207, 208. It may be possible, in certain configurations, to eliminate this second support for the piston chamber.

Of course, numerous modifications will be able to be made to the invention without leaving its scope.

1-14. (canceled)

15. A method of fabrication of a pressure accumulator for a vehicle, comprising:
forming an enclosure around a chamber from a parison of thermoplastic material by applying at least one portion, at least partly molten, of the parison to at least one portion of the chamber to attach the parison to the chamber.

16. The method as claimed in claim 15, wherein the chamber comprises a bladder.

17. The method as claimed in claim 15, wherein the chamber comprises at least one piston assembly.

18. The method as claimed in claim 15, wherein the chamber is attached to an extrusion head of the parison, by a robot.

19. The method as claimed in claim 15, wherein the portion or each portion of the chamber is heated prior to applying of the parison to that portion.

20. The method as claimed in claim 15, wherein the applying is done by pressure.

21. The method as claimed in claim 15, wherein the applying is done by closing of a mold for a molding of the enclosure from the parison.

22. The method as claimed in claim 15, wherein the portion of the chamber or at least one of the portions of the chamber forms a lower or upper end of the chamber, or a valve, and the applying is performed at the lower and upper ends.

23. The method as claimed in claim 15, wherein the portion of the chamber or at least one of the portions of the chamber constitutes an assembly composed of elements which can only be separated by destruction of at least one of the elements.

24. The method as claimed in claim 15, wherein the portion of the chamber or at least one of the portions of the chamber has an external face formed by a thermoplastic material and the applying is performed by applying the parison to the external face.

25. A pressure accumulator for a vehicle, comprising:
an enclosure of thermoplastic material; and
a chamber housed in the enclosure, the enclosure being at least partly overmolded on at least one portion of the chamber.

26. The accumulator as claimed in claim 25, wherein the chamber comprises a bladder.

27. The accumulator for a vehicle as claimed in claim 25, wherein:
the chamber comprises a piston assembly; and
overmolding of the enclosure takes place on portions of the chamber forming at least one portion of a first nozzle for an inlet and outlet of a pressurized gas and at least one portion of a second nozzle for an inlet and outlet of a pressurized liquid.

28. The accumulator as claimed in claim 25, wherein:
the chamber comprises a piston assembly;
overmolding of the enclosure takes place on at least one portion of a first peripheral nozzle for an inlet and outlet of a pressurized gas;
the chamber comprises a second central nozzle for an inlet and outlet of a pressurized liquid; and
the first and second nozzles are placed on a same side of the accumulator.
